(19) United States
(12) Patent Application Publication
(10) Pub. No.: US 2026/0361973 A1
(43) Pub. Date: Nov. 12, 2026

(54) BASEBOARD MANAGEMENT CONTROLLER-BASED GENERATION OF EARLY VIDEO DURING HOST BOOTS

(71) Applicant: HEWLETT PACKARD ENTERPRISE DEVELOPMENT LP, Spring, TX (US)

(72) Inventors: Darrell R. Haskell, Spring, TX (US); David F. Heinrich, Spring, TX (US); Theodore F. Emerson, Spring, TX (US); Kaitlin Arnold, Spring, TX (US); Walton A. Rosen, Spring, TX (US); Andrew C. Cartes, Spring, TX (US)

(21) Appl. No.: 19/201,016

(22) Filed: May 7, 2025

(51) Int. Cl. H04N 21/81; H04N 21/443

(52) U.S. Cl. CPC H04N 21/816; H04N 21/4432; H04N 21/4435

(57) ABSTRACT

A technique includes booting a host of a computer platform. Responsive to the booting, a baseboard management controller of the computer platform controls a video display interface of the computer platform. The baseboard management controller manages the host. The control of the video display interface by the baseboard management controller includes communicating, by the baseboard management controller, with the video display interface using an out-of-band communication channel to cause the video display interface to generate a first video output corresponding to first data sent to the baseboard management controller by a host. The technique includes, responsive to the booting, configuring an in-band communication channel of the computer platform and discovering, by the host, the video display interface. The technique includes, responsive to discovering the video display interface, controlling, by the host, the video display interface to cause the video display interface to generate a second video output corresponding to second data sent, by the host, to the video display interface over the in-band communication channel.

### BACKGROUND

A server may include a specialized service processor, called a “baseboard management controller,” or “BMC,” which monitors the physical state of the server and communicates with a management system through a management network. As examples of its roles, a BMC may monitor sensors (e.g., temperature sensors, cooling fan speed sensors and tampering sensors); monitor operating system status; monitor power statuses; log computer system events; and provide remotely-controlled management functions for the computer platform. Moreover, a BMC may allow operations to be performed when a host of the server is powered down.

### BRIEF DESCRIPTION OF THE DRAWINGS

FIG. 1 is a block diagram of a computer platform having a baseboard management controller (BMC)-based solution to generate early video, according to an example implementation.

FIG. 2 is a block diagram of a BMC-based early video architecture, according to an example implementation.

FIG. 3 is a block diagram of a communication channel architecture for communicating with a video display interface, according to example implementations.

FIG. 4 is a sequence flow diagram illustrating, in association with a host boot, communications among and actions taken by components of an early video solution, according to an example implementation.

FIG. 5 is a block diagram of a computer platform having a BMC that manages the generation of early video, according to an example implementation.

FIG. 6 is a flow diagram depicting a technique to control a video display interface during a boot of a host of a computer platform, according to an example implementation.

FIG. 7 is an illustration of a storage medium that stores hardware processor-readable instructions that, when executed by a hardware processor, cause a baseboard management controller of a computer platform to control a video display interface during an early stage of a boot of a host of the computer platform, according to an example implementation.

### DETAILED DESCRIPTION

A computer platform (e.g., a server) may have a video display interface for purposes of providing a local visual output for the platform. The video display interface provides signals that collectively correspond to a video output and when received by a display device, such as a television or monitor, produce a video. In the context that is used herein, a “video” refers to a stream or series of visual images.

A host of a computer platform may communicate with a video display interface using a primary, or in-band, communication channel. In an example, the host may, via the in-band communication channel, write data representing pixel color values and coordinates to either the video display interface or to a frame buffer that is associated with the video display interface.

A video display interface's in-band communication channel may be unavailable when the host first boots. The initial unavailability of the in-band communication channel during a host boot is due to the in-band communication channel undergoing a complex configuration. A “complex configuration,” in the context that is used herein, generally refers to a boot process involving the execution of firmware to set up multiple attributes of an in-band communication channel, including one or more of selecting a communication protocol for the in-band communication channel and selecting a data width of the in-band communication channel. A Peripheral Component Interconnect express (PCIe) link is an example of an in-band communication channel that is subject to a complex configuration. A PCIe link is not is not available in the initial part of a boot until the corresponding PCIe root complex is initialized and configured. The initialization and configuration of a PCIe root complex is associated with an ever-increasing amount of complex and sophisticated firmware execution. Waiting for firmware to configure a PCIe root complex means that there may be a substantial delay (e.g., seconds) after the beginning of a boot before any PCIe links that are associated with the PCIe root complex are available. In examples, the initialization and configuration of the PCIe root complex may involve, among other operations, PCIe link training to establish PCIe link parameters (e.g., data rates and equalization parameters); selecting whether particular PCIe lanes use PCIe or Compute Express Link (CXL) protocols; selecting lane groupings; selecting lane widths; and selecting link supply voltages.

For an endpoint device that is connected to a host by an in-band communication channel that is subject to complex configuration, the endpoint device cannot be discovered and therefore used by the host until the corresponding complex configuration is complete. For the case of a video display interface that is connected to a host via an in-band communication channel that is subject to complex configuration, a corresponding lengthy video availability delay (e.g., a delay of seconds) is imposed when the host boots.

A video availability delay may be more pronounced for a computer platform that has a server-on-a chip (SoC)-based architecture. A system-on-a-chip is an integrated circuit that contains components, such as processing cores and a memory, for purposes of providing general purpose computing for a number of purposes, such as mobile user devices, client devices and servers. A server-on-a-chip, or “SoC,” in the context that is used herein, is a system-on-a-chip that is specialized to provide server functions. In an example, an SoC includes main components of a server, such as central processing unit (CPU) cores, a memory controller interface and a storage controller interface. An SoC may further include one or multiple service processors.

When a computer platform containing an SoC initiates a boot, the SoC powers up, and then the SoC performs initialization operations (called “SoC initialization operations” herein). In examples, the SoC initialization operations include the SoC initializing its service processors, PCIe root ports and external interfaces (e.g., memory interfaces and storage interfaces). Moreover, other SoC initialization operations (e.g., initializing and training system memory) may extend outside of the SoC. A boot CPU core of the SoC does not begin loading and executing system firmware (e.g., basic input/output system (BIOS) and Unified Extensible Firmware Interface (UEFI) firmware) until the SoC initialization operations complete.

Upon receiving power, an SoC performs the SoC initialization operations before a main CPU core begins executing system firmware. The resulting video availability delay may span from several seconds to several minutes after the initiation of the host boot.

In accordance with example implementations that are described herein, an early video solution provides early video for a computer platform, even though a video display interface of the computer platform is connected to an in-band communication channel that is subject to a complex configuration. The early video solution uses a secondary, or out-of-band, communication channel to control the video display interface during the initial, or early, part of the host boot. In the context used herein, “early” video refers to video that is associated with a host boot and occurs in the initial portion of the boot before the host's discovery of the video display interface. In an example, early video for a host begins at or near the initiation of the host boot (e.g., an initiation corresponding to a power on button being depressed) and ends at, near or after the discovery of the video display interface by the host. As can be appreciated, due to the early video solution, an initial unavailability of a video display interface's in-band communication channel during a host boot does not impact the computer platform's ability to provide early video.

The absence of early video for a computer platform may have detrimental consequences. In an example, a host boot may encounter a problem that causes the boot to fail (e.g., hang up, or stall) before the host discovers the video display interface. Because, for this example, the boot fails before the host discovers the video display interface, the computer platform does not produce any visual output. The visual output, if available, may have provided useful information from which a troubleshooter could have derived a reason to explain why the boot failed. Even if a boot survives a problem that occurs before the host's discovery of the video display interface, there may be no content in the video produced after the discovery of the video display interface to bring attention to the earlier encountered problem.

In another example of a detrimental consequence of not having early video, the absence of early video may lead to a perceived problem with a boot (even though the boot encounters no problems). Perceived boot problems may be especially prevalent for an SoC-based architecture, which has an ever-increasing complexity (e.g., an ever-increasing number of service processors that are initialized for a boot). In another example, the lack of early video may have financial implications. For example, the lack of early video may result in a warranty claim (e.g., a server replacement claim) when the actual problem (e.g., an unseated dual inline memory module (DIMM) that caused the boot to hang) is relatively minor and could have been readily resolved if early video was available to reveal the problem.

In accordance with example implementations that are described herein, a computer platform includes a host and a baseboard management controller (BMC) that manages the host. The BMC participates in an early video solution for the computer platform. More specifically, for purposes of producing early video, the BMC serves as an early video intermediary between the host and a video display interface that is yet to be discovered by the host.

In an example, at the beginning of a boot before system firmware execution begins, an SoC of a computer platform powers up and initializes hardware components and interfaces of the computer platform. In an example, the SoC participates in initialization and training of a system memory of the computer platform. The SoC, for this example, communicates with the BMC for purposes of generating early video content (e.g., error messages and initialization progress) related to the SoC initialization. In another example, the host, when executing system firmware, communicates with the BMC for purposes of generating early video content (e.g., error messages, logos and progress bars) related to the system firmware execution. The BMC uses a secondary, or out-of-band, communication channel to control the video display interface during the initial part of a host boot for purposes of producing the early video. Unlike the in-band communication channel, the out-of-band communication channel is not subject to complex configuration.

In accordance with example implementations, the host asynchronously sends data to the BMC during the early video time period over a serial connection between the SoC and the BMC. More specifically, in accordance with example implementations, the host sends, via the serial connection, video content-related commands (called “display commands” herein) to the BMC. Each display command includes data that represents a command code that identifies a particular feature (called an “early video feature” herein) for the early video. In an example, an early video feature is a video content item (e.g., an error message or a progress bar status) to be included in the early video. In another example, an early video feature is an organization or effect (e.g., a scrolling effect or flashing text) to be applied to content of the early video.

The BMC, in one example, uses a look-up table to map received command codes to their respective early video features. The BMC writes to the video display interface using the out-of-band communication channel so that the early video has, or contains, the early video features that are indicated by the received command codes. The writes by the BMC may include writes to a display memory (e.g., a frame buffer) of the video display interface as well as writes to registers of a video controller of the video display interface. Moreover, the control of the video display interface by the BMC may involve the BMC reading from the video display interface, such as reading contents of the registers.

In accordance with example implementations, the host controls when the early video ends, and therefore, the host controls when the host takes over control of the video display interface. In an example, after discovery of the video display interface, the host allocates system resources for the video display interface and configures the video display interface, thereby enabling the use of the video display interface via the in-band communication channel. As described herein, depending on the particular implementation, the host may or may not notify the BMC about the host's takeover of the video display interface.

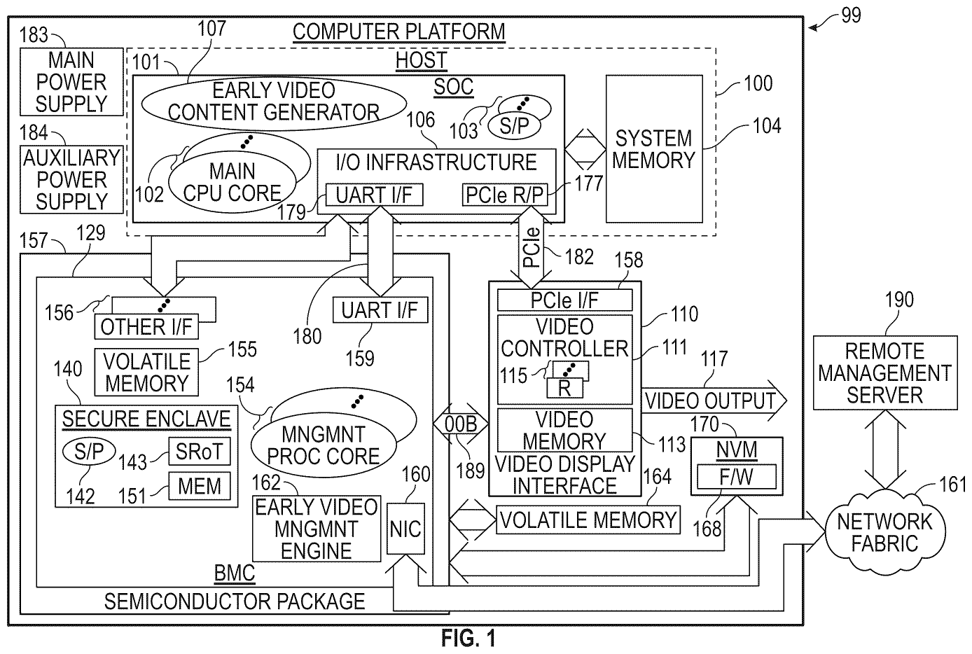

Referring to FIG. 1, as a more specific example, in accordance with some implementations, a computer platform 99, among its other components, includes a primary, or main, power supply 183; a secondary, or auxiliary, power supply 184; a host 100; a video display interface 110; and a baseboard management controller (BMC) 129. The auxiliary power supply 184 provides auxiliary power for the power consuming components of the BMC 129 when AC power is available (e.g., when a power cord for the computer platform 99 is plugged into a power receptacle). The main power supply 183, when enabled, provides main power to the power consuming components of the host 100.

In accordance with example implementations, the host 100, among other possible components, includes a server-on-a-chip (SoC) 101 and a system memory 104. The SoC 101 includes main CPU cores 102, which execute firmware and software for the computer platform 99, such as system firmware, applications, virtualization software, an operating system (e.g., a Linux or Windows operating system) and so forth.

The SoC 101 includes one or multiple service processors 103. A management engine is an example of a service processor. A management engine may provide such features as out-of-band management services, a protected audio/video path (e.g., providing high-bandwidth digital content protection (HDCP)), a firmware-based trusted platform module (TPM), as well as provide other components and services for the computer platform 99. In another example of a service processor 103, the SoC 101 may include one or multiple reliability, availability and serviceability (RAS) processors. A RAS processor may perform any of a number of functions, such detecting and correcting hardware-related errors (e.g., correcting memory errors and storage device errors), protecting data integrity, monitoring computer platform health, monitoring computer platform component performances, provided automatic failure recovery, providing failover, providing for preventative maintenance for the computer platform 99, providing diagnostic reporting, and so forth.

The SoC 101 includes an input/output (I/O) infrastructure 106. The I/O infrastructure 106 allows communications between the main CPU cores 102 and the BMC 129, as well as allows the main CPU cores 102 to communication with peripheral components, such as one or multiple storage drives; one or multiple Universal Serial Bus (USB) devices; I/O devices; and so forth. Moreover, the I/O infrastructure 106 may include one or multiple network interface controllers (NICs). In accordance with further implementations, in another example, the computer platform 99 does not include an SoC, but rather, the computer platform 99 includes multi-core CPU semiconductor packages and one or multiple other semiconductor packages corresponding to one or multiple I/O bridges.

The I/O infrastructure 106 may take on any one of a number of different forms and architectures. In an example, the I/O infrastructure 106 includes one or multiple buses and one or multiple bridges connecting the buses. In another example, the I/O infrastructure 106 includes a memory controller and system memory interface. In another example, the I/O infrastructure 106 includes one or multiple storage device interfaces. In another example, the I/O infrastructure 106 includes accelerator interfaces. Depending on the particular implementation, the I/O infrastructure 106 may be fully or partially integrated with the main CPU cores 102 or may be separate from the main CPU cores 102.

In an example, the I/O infrastructure 106 includes one or multiple PCIe root complexes. In an example, each main CPU core 102 corresponds to a PCIe root complex and has an associated collection of PCIe root ports. For the example implementation that is depicted in FIG. 1, the I/O infrastructure 106 includes an exemplary PCIe root port 177, and the video display interface 110 is connected to the PCIe root port 177 by a PCIe link 182.

In accordance with example implementations, the PCIe link 182 serves as a primary, or in-band, communication channel over which the host 100 may control the video display interface 110 for purpose of generating video. Because the PCIe link 182 is subject to a complex configuration each time the host 100 boots, there is an initial period of time during a boot of the host 100 in which the video display interface 110 is undiscovered by the host 100. As such, without the early video solution that is described herein, early video for the computer platform 99 would otherwise be unavailable.

The PCIe link 182, similar to other PCIe links of the computer platform 99 is subject to complex configuration at the beginning of a host boot. The video display interface 110, cannot be discovered by PCIe enumeration until the complex configuration is complete. The complex configuration may be associated with the execution of complex and sophisticated firmware instructions, which may span several seconds. In an example, the complex configuration involves system firmware configuring a PCIe root complex associated with the PCIe link 182. Configuring the host 100 to bring the host 100 to a state in which the PCIe root complexes may be configured may involve the execution of several seconds of system firmware. For example, the PCIe root complex configuration may require system memory 104, CPU caches and/or other configured resources of host 100 to execute properly. Thus, the PCIe root complex configuration is performed after these operations and accordingly, does not finish until several seconds or minutes after power is applied to the host CPU After completion of the complex configuration and the discovery of the video display interface 110, the host 100 allocates system resources for the video display interface 110 and configures the video display interface 110 based on this allocation. The host 100 may thereafter communicate with the video display interface 110 via the PCIe root port 177.

The I/O infrastructure 106 includes a serial port, such as a port that corresponds to a Universal Asynchronous Receiver-Transmitter (UART) interface 179. Using the UART interface 179, the host 100 communicates with the BMC 129 for purposes of producing early video, as further described herein. The I/O infrastructure 106, in accordance with example implementations, includes other communication interfaces that are connected to respective communication interfaces 156 of the BMC 129. In an example, the I/O infrastructure 106 and the BMC 129 may communicate over one or multiple of the following communication links: an Inter-Integrated Circuit (or “I2C”) bus, an Improved I2C (or “I3C”) bus, a Serial Peripheral Interface (or “SPI”) bus, an enhanced SPI (or “eSPI”) bus, a system management bus (SMBus), as well as other communication links.

The BMC 129 powers up when auxiliary power is available. The powering up of the host 100 (i.e., the enabling of the main power supply 183) occurs later in response to a host power on request. In an example, a host power on request corresponds to a power button of the computer platform 99 being depressed. In another example, a host power on request is initiated by the BMC 129 instead of the host power on request being initiated by a power button being depressed. A host power on request triggers a boot of the host 100. In the context that is used herein, a “boot” (or “boot up”) of a host refers to a process of starting up the host, beginning with power being provided to the host and ending with control of the host being passed to an operating system.

A host boot may first include a hardware initialization phase, or stage, and the hardware initialization stage is proceeded by the execution of system firmware that performs further platform initialization. Regarding the execution of system firmware, example implementations are described herein in which the computer platform 99 undergoes a “UEFI boot” and as part of the UEFI boot, executes UEFI system firmware for purposes of performing platform initialization and ultimately loading the operating system. All or part of the system firmware may not be UEFI firmware, however, in accordance with further implementations. For example, in accordance with further implementations, the computer platform 99 performs a “legacy-boot,” in which the computer platform 99 relies solely on the execution of legacy BIOS firmware for platform initialization and loading of the operating system. In another example, the computer platform 99 executes “Linux-boot” system firmware that contains some UEFI firmware, but driver execution environment (DXE) modules of the UEFI firmware are replaced with the Linux kernel. In another example, the computer platform 99 executes Coreboot system firmware to perform platform initialization. In another example, the computer platform 99 performs a Universal-Boot, or “U-boot,” in which the computer platform 99 executes a U-boot loader to load the operating system. The early video solution that is described herein provides early video regardless of the particular type of boot environment.

In an example, responsive to receiving main power and powering up, the SoC 101 performs initialization operations that precede the execution of UEFI firmware by a boot main CPU 102 of the SoC 101. In an example, the initialization operations performed by the SoC 101 include the SoC 101 initializing the I/O infrastructure 106. In another example, the initialization operations by the SoC 101 include the SoC 101 participating in the initialization and training of the system memory 104. In another example, the initialization operations of the SoC 101 include the SoC initializing the service processors 103. In another example, the initialization operations of the SoC 101 include the SoC 101 initializing peripherals that are connected to the SoC 101.

In accordance with example implementations, the BMC 129, for each host boot, controls when (if at all) the execution of UEFI firmware begins. In accordance with example implementations, the main CPU cores 102 are held in reset when the main CPU cores 102 power up, and the BMC 129 controls when the main CPU cores 102 are released from reset. More specifically, the BMC 129 performs various checks for purposes of determining whether the main CPU cores 102 are allowed to be released from reset. In an example of the checks, the BMC 129 validates firmware 168 (e.g., firmware corresponding to a BMC firmware management stack image and the UEFI firmware) that is stored in a non-volatile memory 170 of the computer platform 99. In another example, the BMC 129 checks for hardware faults of the computer platform 99.

If the BMC 129 determines, responsive to the checks, that the boot of the host 100 is allowed to proceed with executing UEFI firmware, then the BMC 129 releases the main CPU cores 102 from reset. The release of the main CPU cores 102 from reset allows a designated main boot CPU core 102 to execute the UEFI firmware.

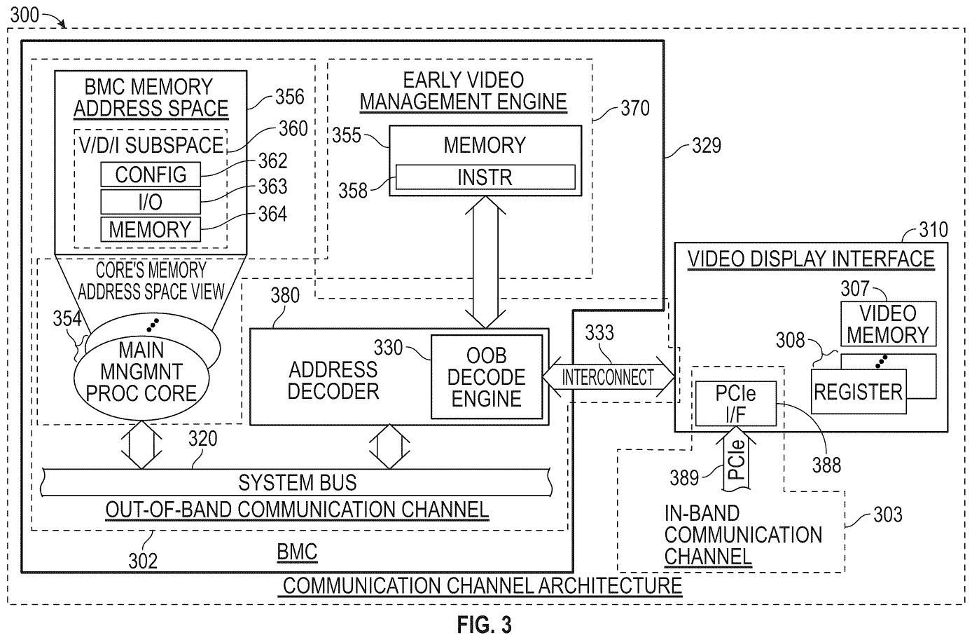

In accordance with example implementations that are described herein, the BMC 129 includes an early video management engine 162 (or “early video offload management engine 162”). The early video management engine 162 serves as an early video intermediary for the host 100 for purposes of providing early video. More specifically, in accordance with example implementations, responsive to a host power on request, the early video management engine 162 configures the video display interface 110 to be initially controlled by the engine 162. In accordance with example implementations, the configuration occurs via communications over an out-of-band communication channel 189. An example implementation of the out-of-band communication channel 189 is described below in connection with FIG. 3.

Still referring to FIG. 1, during the early part of a host's boot before the host's discovery of the video display interface 110, the host 100 communicates with the early video management engine 162 via a communication link 180. The communication link 180 may be considered an out-of-band communication channel between the SoC 101 and the BMC 129. In an example and as depicted in FIG. 1, the communication link 180 is an asynchronous serial data exchange connection between the UART interface 179 of the SoC 101 and a UART interface 159 of the BMC 129. In accordance with further implementations, communication technologies links other than UART-based communication may be used for the communication link 180, such as an I2C bus, an I3C bus, a SPI bus, an eSPI bus, an SMBus, and so forth. In these implementations, the early video management engine 162 may communicate with the SoC 101 using one of the BMC's other communication interfaces 156.

The host 100 includes one or multiple early video content generators 107 that are present at different times during the early part of the host boot (before the host's discovery of the video display interface 110). An SoC initialization engine that performs initialization operations for the SoC 101 in response to the SoC 101 powering up is an example of an early video content generator 107. UEFI firmware that executes when the main CPU cores 102 are released from reset is another example of an early video content generator 107. The early video content generator 107 determines content for the early video and sends, to the BMC's early video management engine 162, data representing video content-related commands, which are referred to herein as “display commands.”

In a more specific example, during the initial initialization stage of a host boot, an SoC initialization engine (e.g., a hardware component of the SoC 101) performs initialization operations for the SoC 101 prior to the execution of UEFI firmware by the main CPU cores 102. In association with the initialization operations, the SoC initialization engine determines features for the early video, determines display commands corresponding to these features, and sends, via the communication link 180, the display commands to the early video management engine 162.

In an example, the SoC initialization engine determines that a startup image is to be included in the early video to visually indicate the beginning of the host boot, and the SoC initialization engine sends, to the early video management engine 162, a display command that corresponds to the startup image. In another example, the SoC initialization engine determines that a certain percentage of progress of the SoC's initialization is to be visually displayed, and the SoC initialization engine sends, to the early video management engine 162, a display command that corresponds to the progress bar percentage. In another example, the SoC initialization engine determines that an error has occurred during the SoC's initialization, and the SoC initialization engine sends, to the early video management engine 162, a display command that corresponds to a specific error message to be included in the early video. In another example, the SoC initialization engine sends, to the early video management engine 162, a display command that corresponds to a message indicating that a particular phase of the SoC's initialization is occurring. In another example, the SoC initialization engine determines that the SoC's initialization is complete, and the SoC initialization engine sends, to the early video management engine 162, a display command that corresponds to a message that indicates that the SoC's initialization is complete.

After the SoC initialization is complete, UEFI firmware (another example of an early video content generator 107) begins to execute (assuming that the BMC 129 allows the main CPU cores 102 to be released from reset). The UEFI firmware performs a sequence of UEFI platform initialization phases. In association with the sequence of UEFI platform initialization phases, the UEFI firmware determines early video features, determines display commands corresponding to the early video features, and sends, via the communication link 180, corresponding display commands to the early video management engine 162.

In an example, the UEFI firmware determines that an image is to be included in the early video to visually indicate the beginning of UEFI firmware execution, and the UEFI firmware sends, to the early video management engine 162, a display command that corresponds to the startup image. In another example, the UEFI firmware determines that a certain percentage of progress of the host boot or a certain percentage of progress of the UEFI initialization is to be included in the early video, and the UEFI firmware sends, to the early video management engine 162, a display command that corresponds to the progress bar percentage. In another example, the UEFI firmware determines that a message that represents the current UEFI initialization phase is to be included in the early video, and the UEFI firmware sends, to the early video management, a corresponding display command. In another example, UEFI firmware determines that an error has occurred, and the UEFI firmware sends, to the early video management engine 162, a display command that corresponds to a specific error message to be included in the early video.

In examples, an early video feature may be a video content item, such as a progress bar, a progress bar update percentage, a message, an icon, an image, a logo, a single character, multiple characters, or any other visually displayed element or group of elements. In another example, an early video feature may be an organization or effect to be applied to the early video, such as a rearrangement of already display elements of the early video, flashing text, scrolling, and so forth.

In an example, a display command corresponds to a sequence of American Standard Code for Information Interchange (ASCII) characters representing a string of characters. In an example, the sequence has an order that corresponds to the order in which bits are communicated over the communication link 180. In an example, a beginning part, or prefix, of the string or another designated part of the string (as another example), serves as a label to indicate that the remainder of the string corresponds to a code (called a “command code” herein) that identifies an early video feature. In an example, a prefix of the string represents an escape sequence of characters, which alerts the early video management engine 162 to reception of a display command over the communication link 180.

The early video management engine 162, in one example, uses a look-up table to map a given command code to the specific corresponding early video feature, and the early video management engine 162 accesses (e.g., writes to) the video display interface 110 using the out-of-band communication channel 189 to apply the early video feature to the early video. In an example, the early video management engine 162 writes, using the out-of-band communication channel 189, to a video memory 113 (e.g., a video display memory) of the video display interface 110 for purposes of including a video content item in the early video. In another example, the early video management engine 162 writes, using the out-of-band communication channel 189, to a register 115 of a video controller 111 of the video display interface 110 for purposes of applying an effect to the early video. In another example, for purposes of including applying a particular early video feature to the early video, the early video management engine 162 may initiate multiple transactions with video display interface 110 via the out-of-band communication channel 189, including one or multiple write transactions, one or multiple read transactions, or a combination of the foregoing.

The display commands correspond to a compact and communication efficient way for the SoC 101 (e.g., an SoC initialization engine of the SoC 101 or UEFI firmware executing in the SoC 101) to inform the early video management engine 162 about features (called “early video features” herein) to include in the early video. Moreover, the use of the display commands allows any of a number of SoCs 101 associated with different manufacturers to be incorporated into a particular computer platform 99 and be used in an early video solution. In this manner, an original equipment manufacturer (OEM) of the computer platform 99 may provide, for SoC manufacturers, a specification detailing the syntax of the display command. Moreover, the specification may set forth a mapping between command codes and respective early video features. In an example, a look-up table corresponding to the mapping may be represented by data that is stored in a UEFI volume, which is accessible by the early video management engine 162.

The end of the early video coincides with the host's discovery of the video display interface 110, the host's allocation of system resources for the video display interface, and the host's configuration of the video display interface 110. The end of the early video means that the host 100 may thereafter communicate with the video display interface 110 via the PCIe link 182. Responsive to the end of the early video, the host 100 may, in an example, send, via the communication link 180, a notification (called a “video takeover notification” herein) to the early video management engine 162 to notify the engine 162 that the host 100 is taking over control of the video display interface 110. Responsive to the video takeover notification, the early video management engine 162 relinquishes control of the video display interface 110. Therefore, until the host 100 powers down or is reset, the video display interface 110 is controlled by the host 100.

The duration of the early video, in accordance with example implementations, depends on how the UEFI firmware implements PCIe enumeration. In an example, during a boot of the host 100, UEFI firmware transitions through a sequence of UEFI platform initialization phases, beginning with a security, or “SEC,” phase. After the SEC phase, the UEFI firmware begins a pre-EFI, or “PEI phase,” of the platform initialization. In the PEI phase, in an example, the UEFI firmware initializes OEM hardware of the host 100, such as the main CPU cores 102 and the system memory 104. In an example, the UEFI firmware, in the PEI phase, performs PCIe enumeration that results in the discovery of the video display interface 110, the configuration of the video display interface and the allocation of system resources for the video display interface 110. In an example, the PCI enumeration in the PEI phase may be restricted in scope, such as a scope that is limited to discovering the video display interface 110. In an example, the PCIe enumeration may be limited to the PCIe root port 177, which is dedicated for the video display interface 110.

The PEI phase is proceeded by a subsequent, driver execution environment, or “DXE,” phase of the UEFI platform initialization. In the DXE phase, the UEFI firmware, among other actions, completes initialization of the computer platform hardware, executes option read only memory (ROM) firmware drivers and sets up UEFI runtime services for the post boot environment. In an example, in the DXE phase, the UEFI firmware performs PCIe enumeration for purposes of discovering PCIe endpoint devices. In an example, for implementations in which the UEFI firmware performs limited PCIe enumeration in the PEI phase to discover the video display interface 110, the UEFI firmware performs PCIe enumeration in the DXE phase to discover the remaining PCIe endpoint devices of the computer platform 99. In another example, the UEFI firmware does not perform any PCIe enumeration in the PEI phase, and the UEFI firmware performs PCIe enumeration solely in the DXE phase for purposes of discovering all PCIe endpoint devices of the computer platform 99, including the video display interface 110.

The computer platform 99, in accordance with example implementations, is a modular unit, which includes a frame, or chassis; and the modular unit includes hardware that is mounted to the chassis and is capable of executing machine-readable instructions (e.g., software and/or firmware instructions). In examples, the computer platform 99 is a server, such as a blade server, a rack server or a tower server. In other examples, the computer platform 99 may be a device other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device.

In the context that is used herein, a “video display interface” generally refers to a subsystem of a computer platform, which provides a collection of video output signals (e.g., digital signals, analog signals or a combination of digital and analog signals) that, when received by a display device, such as a monitor or a television, cause the display device to display a video. As depicted in FIG. 1, the video display interface 110 provides a video output 117 corresponding to video output signals. Although not depicted in FIG. 1, the computer platform 99 includes a connector to electrically and mechanically mate with a display cable for purposes of routing the video output 117 to a display device. In an example, the video display interface 110 is external to the BMC 129 and is powered by main power provided by the main power supply 183. In another example, the video display interface 110 is part of the BMC 129 and is powered by auxiliary power provided by the auxiliary power supply 184.

The video display interface 110 may have any of a number of architectures. In an example, the video display interface 110 is Video Graphics Array (VGA)-compliant. In this manner, the video display interface 110 is constructed to convert digital video input data into analog video signals (the video output 117 for this example) that correspond to the VGA standard. The analog video signals, for this example, correspond to the terminals, or pins, of a VGA connector (e.g., a female DE-15 connector, for example). In the context that is used herein, the “VGA standard” refers to the original VGA standard that was introduced in 1987, as well as variants from the original VGA standard, such as, Super VGA (SVGA) standard, the XGA standard and so forth. In another example, the video display interface 110 provides a Digital Visual Interface (DVI)-compliant video output 117, which includes a collection of signals corresponding to a digital video output and a collection of signals corresponding to an analog video output. In other examples, the video display interface 110 solely provides a digital video output 117, such as a High-Definition Multimedia Interface (HDMI)-compliant video output, a DisplayPort-compliant video output, or a digital video output 117 that complies with another standard.

In the context that is used herein, an “in-band communication channel” refers to the main, or primary, pathway used by a host to communicate with a component (e.g., the video display interface 110). In an example, the in-band communication channel for the video display interface 110 includes a PCIe root complex (which has an associated PCIe root port 177), the PCIe link 182 and a PCIe endpoint interface 158 of the video display interface 110. In another example, an in-band communication channel for the video display interface 110 includes a PCIe switch. In another example, an in-band communication channel for the video display interface 110 includes a non-PCIe link that is subject to complex configuration before the link can be used.

In the context that is used herein, an “out-of-band communication channel” refers to a pathway to communicate with a component, which is an alternate, or is secondary, to the component's in-band communication channel. The host 100 may not be able to access a component using the component's out-of-band communication channel, and in accordance with example implementations, the host 100 cannot access the video display interface 110 using the video display interface's out-of-band communication channel 189.

In the context that is used herein, a “host” refers to a collection of components of a computer platform, which have an unabstracted view of resources of the computer platform 99. These resources support (or “host”) one or multiple application operating environments in which application workloads execute. In examples, an application operating environment may be a virtual machine, a container, a container pod, an orchestrated container cluster, a bare-metal environment, a combination of the foregoing or any other ecosystem that supports the execution of application workloads. An application workload may be an application process or a collection of application processes that operate under the same identity.

In accordance with example implementations, the host 100 is part of a printed circuit board assembly (PCBA), such as a host processor module (HPM), of the computer platform 99; and the BMC 129 is part of a separate PCBA of the computer platform 99. In an example, in accordance with some implementations, the BMC 129 is part of a Datacenter-ready Secure Control Module (DC-SCM) and the DC-SCM connects to an HPM (e.g., an HPM containing the host 100 and the video display interface 110) through a Datacenter-ready Secure Control Interface (DC-SCI).

For the computer platform 99, the host 100 may have an unabstracted view of main CPU cores 102, a system memory 104, an operating system, as well as other resources of the computer platform 99. After a successful boot, the host 100 operates under control of the operating system independently of the BMC 129. In accordance with some implementations, the computer platform 99 may contain multiple hosts 100. The BMC 129 manages each host 100, and this management includes, in accordance with example implementations, the BMC 129 providing management services and security services for the host 100.

The BMC 129, in accordance with example implementations, has a management plane and a security plane. The management plane includes one or multiple main management processing cores 154 that execute a set of firmware instructions, called a “firmware management stack,” for purposes of performing a variety of management services for host(s) 100 of the computer platform 99.

As examples, the BMC 129 provides such management services as operating system runtime services; resource detection and initialization; and pre-operating system services. Some management services may be remotely-managed. As examples, remotely-managed management services include keyboard video mouse (KVM) services; virtual power services (e.g., remotely-activated services to remotely set a power state of a host 100, such as a power conservation state, a power on, a reset state or a power off state); and virtual media management services.

The BMC 129 provides security services as part of its security plane. In examples, the security services may include firmware validation; managing the storage of cryptographic artifacts (e.g., certificates, seeds, cryptographic keys; measurements; and passwords) for the host(s) 100; encryption; decryption; tamper detection; random number generation; pseudorandom number generation; hash generation, measurement signing; and/or other security-related operations.

In accordance with example implementations, the BMC's security plane includes a secure enclave 140. In another example, the BMC 129 does not include a secure enclave 140. In this context, a “secure enclave” refers to a subsystem for which access into and out of the subsystem is tightly controlled. In accordance with example implementations, the secure enclave 140 is fully contained inside a cryptographic boundary. A “cryptographic boundary,” in this context, refers to a continuous boundary, or perimeter, which contains the logical and physical components of a cryptographic subsystem, such as BMC components that form the secure enclave 140. The secure enclave 140, in accordance with example implementations, is isolated from the BMC's management plane, and the secure enclave 140 is isolated from other non-secure components of the BMC 129, which are outside of the secure enclave 140.

The secure enclave 140 includes a security processor 142 (e.g., a collection of one or multiple processing cores, such as one or multiple CPU cores). The security processor 142 executes firmware instructions to provide at least some of the BMC's security services. The secure enclave 140 may also include dedicated hardware components to provide other security services for the BMC 129, such as cryptographic accelerators, a random number generator (RNG), a deterministic random number generator (DRNG), a cryptographic hash generator, a tamper detection engine and so forth.

In accordance with example implementations, the secure enclave 140 includes a silicon root of trust (SRoT) engine 143, which is a hardware-based trust anchor for the computer platform 99. Responsive to receiving auxiliary power from the auxiliary power supply 184, the SRoT engine 143 controls reset logic (not shown) to hold the security processor 142 and the main management processing cores 154 in reset. Moreover, the SRoT engine 143 controls the reset logic to hold the main CPU cores 102 in reset when the main CPU cores 102 receive main power. The SRoT engine 143 releases the security processor 142 from reset responsive to successful validation of an initial portion of the firmware 168. As part of the validation, the SRoT engine 143 loads the initial portion of the firmware 168 into a volatile memory 151 of the secure enclave 140. Moreover, in accordance with example implementations, the SRoT engine 143 locks the volatile memory 151 to prevent modification or tampering with the initial portion of the firmware 168 as the content is loaded into the volatile memory 151.

The SRoT engine 143 compares a measurement (e.g., a cryptographic hash) of the initial portion of the firmware 168 against an immutable, expected value that is stored in the secure enclave 140 for purposes of validating the initial portion. If the measurement and expected values are the same, then the initial portion of the firmware 168 passes validation. Responsive to the initial portion of the firmware 168 passing validation, the SRoT engine 143 releases the security processor 142 from reset to allow the security processor 142 to boot and execute the firmware instructions that have been loaded into the volatile memory 151.

By executing the firmware instructions, the security processor 142 may then validate another portion of the firmware 168 that corresponds to a portion of the BMC's management firmware stack and after successful validation, load this portion of the management firmware stack into a volatile memory 155 of the BMC 129. In accordance with some implementations, the loading of this portion of the management firmware stack may occur concurrently with the validation of the portion. After successful validation of this other portion of the firmware 168, the SRoT engine 143 releases the BMC's main management processing core(s) 154 from reset. Responsive to being released from reset, the main management processing core(s) 154 execute the loaded portion of the firmware management stack, which causes the main management processing core(s) 154 to load additional portions of the firmware 168 and place the loaded portions into a volatile memory 164. Access to the volatile memory 164 may involve additional training and initialization steps (e.g., training and initialization steps set forth by the DDR4 specification). Those instructions may be executed from the validated portion of the BMC's firmware management stack in the volatile memory 155.

Therefore, in accordance with example implementations, a cryptographic chain of trust, which is anchored by the SRoT engine 143, may be extended from the SRoT engine 143, the hardware trust anchor, to the firmware management stack that is executed by the BMC's main processing cores 154. Moreover, when a host power on request is received, and the host 100 boots, the chain of trust is extended to host system firmware.

In accordance with example implementations, the BMC 129 is constructed to prevent a given domain or entity of the BMC 129 from powering up or coming out of reset until the secure enclave 140 validates the domain/entity. Moreover, in accordance with example implementations, the BMC 129 may prevent components of the BMC 129 from accessing resources of the BMC 129 and resources of the computer platform 99 until the secure enclave 140 approves or validates the resources. The BMC 129 may perform bus filtering and monitoring to prevent unwanted access to bus devices.

In accordance with example implementations, for purposes of performing its management and security services, the BMC 129 may communicate with a remote management server 190 via a NIC 160 of the BMC 129. As depicted in FIG. 1, the NIC 160 and the remote management server 190 are connected to network fabric 161. In accordance with example implementations, the network fabric 161 may be associated with one or multiple types of communication networks, such as CXL fabric, dedicated management networks, local area networks (LANs), wide area networks (WANs), global networks (e.g., the Internet), wireless networks, or any combination thereof.

In accordance with further implementations, the BMC 129 is connected to the network fabric 161 via a NIC expansion card, or NIC adapter, of the host 100. For example, in accordance with some implementations, the computer platform 99 includes a card edge connector (not shown) that is constructed to receive a NIC adapter that has a host interface (e.g., a PCIe interface) and a sideband channel bus interface. The NIC adapter has one or multiple ports that are connected to the network fabric 161. A sideband channel bus (not shown) of the computer platform 99 connects the BMC 129 to the sideband channel bus interface and allows the BMC 129 to use the NIC adapter for purposes of communicating with the remote management server 190. In an example the sideband channel bus corresponds to the Network Controller Sideband Interface (NC-SI) electrical interface and protocol that are defined by the Distributed Management Task Force (DMTF).

For the example implementation that is depicted in FIG. 1, the BMC 129 is part of a semiconductor package 157. Depending on the particular implementation, the semiconductor package 157 may contain one or multiple dies on which the BMC's components (e.g., the secure enclave 140, the management processing cores 154, the volatile memory 155, the early video management engine 162, and so forth) are fabricated. The semiconductor package 157 may have one of many different forms. In an example, a semiconductor package 157 contains multiple dies that are mounted on a printed circuit board (PCB) substrate that interconnects the dies. In another example, a semiconductor package 157 contains multiple dies that are interconnected by bonding wires. In an example, a semiconductor package is encapsulated. In another example, a semiconductor package 157 is not encapsulated. In other examples, a semiconductor package 157 may correspond to any of a number of different containers, such as a surface mount package, a through-hole package, a ball-grid array package, a small outline package or a chip-scale package. Regardless of its particular form, in accordance with example implementations, the semiconductor package 157 operatively electrically couples its components to a PCBA of the computer platform 99. In an example, the PCBA is a motherboard of the computer platform 99. In another example, the PCBA corresponds to a DC-SCM.

In accordance with example implementations and as depicted in FIG. 1, the video display interface 110 is a standalone component (or a standalone collection of components) external to the BMC 129. In an example, the PCIe endpoint interface 158, the video controller 111 and the video memory 113 are external to the BMC's semiconductor package 157. For these example implementations, the components of the video display interface 110 may be powered by main power that is provided by the main power supply 183. In an example, the components of the video display interface 110, except for the video memory 113, corresponds to a semiconductor package that is mounted to a motherboard of the computer platform 99. In another example, the video display interface 110 is part of a PCBA corresponding to an HPM or DC-SCM. In another example, the video display interface 110 corresponds to a removable adapter card that is installed in an expansion connector slot of the computer platform 99.

In accordance with further example implementations, the BMC 129 contains at least some components of the video display interface 110. For these example implementations, the components of the video display interface 110 may be powered by the auxiliary power supply 184. In an example, components of the video display interface 110, such as the video controller 111 and the PCIe endpoint interface 158, are contained in the BMC's semiconductor package 157. In an example, the video controller 111 and the PCIe endpoint interface 158 are fabricated in one or multiple dies of the semiconductor package 157. In an example, the PCIe endpoint interface 158 corresponds to one of the communication interfaces 156. In an example, the video memory 113 corresponds to a region of the volatile memory 164 or another memory associated with the BMC 129.

As used herein, an “engine,” such as the early video management engine 162 and any other engines that are described herein, can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. In a more specific example, the BMC firmware management stack includes firmware instructions that, when executed by one or multiple main management processing cores 154 of the BMC 129, cause the BMC 129 to provide the early video management engine 162. An “engine” can refer to a combination of one or more hardware processing circuits and machine-readable instructions (software and/or firmware) executable on the one or more hardware processing circuits. In other examples, the early video management engine 162 can be formed in whole or in part by a CPLD, a PLD, an ASIC, an FPGA or other hardware.

In general, the memory devices that form the system memory 104, the volatile memory 151, the volatile memory 155, the volatile memory 164, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

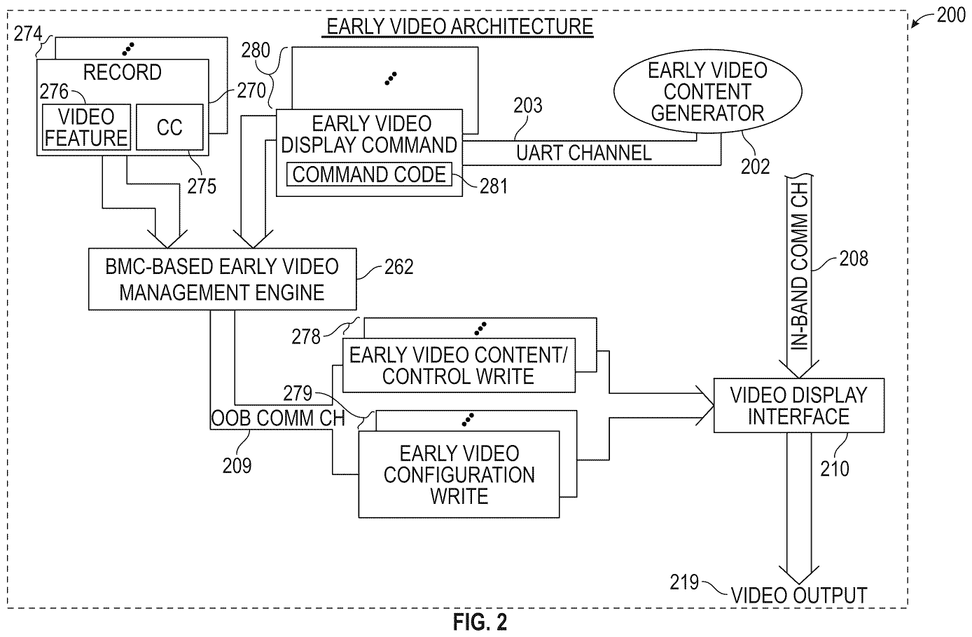

FIG. 2 depicts an early video architecture 200 for a computer platform (e.g., the computer platform 99 of FIG. 1) in accordance with example implementations. Referring to FIG. 2, the early video architecture 200 includes a video display interface 210, a BMC-based early video management engine 262 and an early video content generator 202. The early video content generator 202 is associated with a host of the computer platform. In an example, the early video content generator 202 is an SoC initialization engine that performs initialization operations for the computer platform prior to the execution of system firmware. In another example, the early video content generator 202 is executing system firmware (e.g., UEFI firmware) performing system firmware-based platform initialization prior to host takeover of the video display interface 210. The video display interface 110 and the early video management engine 162 of FIG. 1 are examples of the video display interface 210 and the BMC-based early video management engine 262, respectively.

The video display interface 210 provides a collection of signals forming a video output 219. The video output 219, when received by a display device, causes the display device to display a video for the computer platform. The video display interface 210 is connected to an in-band communication channel 208 (e.g., a PCIe link, such as the PCIe link 182 of FIG. 1), which undergoes complex configuration during a host boot. The in-band communication channel 208 is used by the host to control and communicate with the video display interface 210 after the host executes system firmware to first configure the in-band communication channel 208 and thereafter, discover the video display interface 210.

The BMC-based early video management engine 262, responsive to the initiation of a host boot, prepares, or configures, the video display interface 210 to be controlled by the engine 262. For this purpose, the BMC-based early video management engine 262, as depicted at 279, writes to the video display interface 210 using an out-of-band communication channel 209. In an example, the configuration includes the early video management engine 262 writing to a configuration register of the video display interface 210 via the out-of-band communication channel 209.

During a host boot, the early video content generator 202 determines video features to be included in the video output 219. The early video content generator 202 relies on the BMC-based early video management engine 262 to generate the corresponding early video. More specifically, via the UART-based communication channel 203, the early video content generator 202 sends, to the BMC-based early video management engine 262, display commands 280 for purposes of instructing the engine 262 to include certain features in the early video. Each display command 280, in accordance with example implementations, includes a corresponding command code 281. In an example, a command code 281 identifies a particular early video feature for the early video.

The BMC-based early video management engine 262, in accordance with example implementations, converts a command code 281 into a corresponding early video feature. For this purpose, the BMC-based early video management engine 262 accesses the look-up table 270. The look-up table 270, in accordance with example implementations, contains mapping records 274. Each mapping record 274 is associated with a particular command code 281. Accordingly, the BMC-based early video management engine 262 uses the command code 281 of a display command 280 as an index to identify the appropriate mapping record 274. The mapping record 274 contains data 275 identifying the associated command code 281, and the mapping record 274 contains data 276 identifying or representing an early video feature to which the associated command code 281 is mapped. In examples, the data 276 directly represents an image, a text character, a collection of text characters, a progress bar, a progress bar status, logo, a user option menu, a status, or other early video feature. In another example, the data 276 represents a pointer or other identifier that the BMC-based early video management engine 282 uses to identify the early video feature. In another example, the data 276 represents or identifies an organization or an effect (e.g., scrolling, a flashing effect or element rearrangement) for the early video.

After identifying the early video feature corresponding to a particular command code 281, the BMC-based early video management engine 262, as depicted at 278, initiates one or multiple writes to the video display interface 210 using the out-of-band communication channel 209. In examples, a particular write 278 may be directed to writing video content to a display memory (e.g., a frame buffer) of the video display interface 210 or writing to a control register of a video controller of the video display interface 210. Moreover, controlling the video display interface 210 may include the BMC-based early video management engine 262 reading from the video display interface 210 via the out-of-band communication channel 209. In another example, controlling the video display interface 210 to include the early video feature may include the BMC-based early video management engine 262 performing, via the out-of-band communication channel 209, a combination of one or multiple reads from the video display interface 210 and one or multiple writes to the video display interface 210.

In accordance with further implementations, the BMC-based early video management engine 262 does not use a look-up table to determine early video features for corresponding command codes 281. In an example, the BMC-based early video management engine 262 determines an early video feature for a command code 281 by identifying and applying an applicable rule (e.g., an “if-then” rule) to the command code 281. In an example, a ruleset to derive the early video features may be incorporated into the BMC's firmware management stack. In an example, the ruleset may be represented by data that is accessed by the BMC-based early video management engine 262. In another example, a command code 281 is self-contained (or is “self-describing”). In this manner, the command code 281 directly represents or indicates an early video feature, and therefore, the BMC-based early video management engine 262 determines the early video feature without the use of other information, such as a rule or a look-up table.

The host, as part of platform initialization operations, eventually discovers endpoint devices that are connected to in-band communication channels that configured (such as the in-band communication channel 208), which results in the host's discovery of the video display interface 210. In an example, the in-band communication channel 208 is a PCIe link, and the early video content generator 202 is UEFI firmware. UEFI firmware configures the PCIe root complex associated with the in-band communication channel 208, and through PCIe enumeration, the UEFI firmware discovers the video display interface 210. Responsive to discovering the video display interface 210, the UEFI firmware allocates system resources for the video display interface 210, and then, the UEFI firmware configures the video display interface 210 for the allocated system resources. The host then takes over control of the video display interface 210.

The video display interface 210 is a shared resource in that the video display interface 210 is shared between the host and the BMC-based early video management engine 262 (although at different times). Synchronizing access to the video display interface 210 may occur in any one of a number of different ways. In an example, the synchronization includes the UEFI firmware sending (e.g., sending via the UART-based communication channel 203) a video takeover notification to the BMC-based early video management engine 262 to notify the engine 262 that the host is taking over control of the video display interface 210. The video takeover notification coincides to the end of early video generation and the beginning of video generation using communications that occur over the in-band communication channel 208. The BMC-based early management engine 262 therefore ceases using the video display interface 210 in response to receiving the video takeover notification. In another example, the UEFI firmware does not send a video takeover notification to notify the BMC-based early video management engine 262 about the host's takeover of the video display interface 210, but instead, the UEFI firmware blocks, or prevents, the BMC-based early video management engine 262 from controlling the video display interface 210. For example, responsive to the host taking over control of the video display interface 210, the synchronization includes the UEFI firmware configuring the video display interface 210 so that registers of the video display interface 210 are “read only” to the BMC (thereby preventing the BMC-based early video management engine 262 from controlling or using the video display interface 210).

FIG. 3 is a block diagram of a communication channel architecture 300 for a computer platform (e.g., the computer platform 99 of FIG. 1) in accordance with example implementations. The architecture 300 includes a BMC 329 and a video display interface 310. The BMC 329 includes one or multiple management processing cores 354 and a memory 355. For this example implementation, one or multiple management processing cores 354 execute hardware processor-readable instructions 356 that are stored in the memory 355 for purposes of forming an early video management engine 370. The BMC 129, the early video management engine 162, the video display interface 110, the management processing cores 154 and the volatile memory 164 of FIG. 1 are examples of the BMC 329, the early video management engine 370, the video display interface 310, the management processing cores 354 and the memory 355, respectively.

The early video management engine 370 communicates with the video display interface 310 using an out-of-band communication channel 302. The out-of-band communication channel 302 includes a system bus 320 and an out-of-band decode engine 330 of the BMC 329. The out-of-band communication channel 302 relies on a BMC memory address space 356, which is the memory address space that is viewed by the BMC's main management processing cores 354. As depicted in FIG. 3, the BMC memory address space 356 includes an address subspace 360 (referred to as a video display interface subspace 360 in FIG. 3) that contains BMC memory addresses that correspond to (or are “mapped to”) address spaces of the video display interface 310. In an example, the address subspace 360 includes addresses 362 that correspond to a configuration address space of the video display interface 310. In another example, the address subspace 360 includes addresses 363 that correspond to an I/O address space of the video display interface 310. In another example, the address subspace 360 includes addresses 364 that correspond to a memory address space of the video display interface 310.

Configuration, I/O and memory addresses of the video display interface 310 therefore appear, to the main management processing cores 354, to be within the BMC memory address space. An address decoder 380 (e.g., logic inside a bridge) of the BMC 329 directs transactions (e.g., read and write transactions) on the system bus 320 to the appropriate peripheral destinations based on the addresses of the transactions. The out-of-band decode engine 330 is part of the address decoder 380 and is constructed to direct system bus 320 transactions that target addresses within the address subspace 360 to the appropriate video display interface 310 resources (e.g., registers 308, video memory 307 and I/O ports). For this purpose, the out-of-band decode engine 330, directs a system bus 320 transaction that targets a particular address corresponding to a video display interface resource to an interconnect 333 that is connected to the resource. The communication channel architecture 300 may have multiple interconnects 333.

In an example, a video controller of the video display interface 310 is part of the BMC 329. In an example, a main management processing core 354 may generate a transaction on the system bus 320 targeting an address 362 that corresponds to a configuration space register 308 for such purposes as initializing or configuring the video display interface 310. The out-of-band decode engine 330 recognizes the address 362 and directs the transaction to an interconnect 333 that is connected to the configuration space register 308. For this example, the interconnect 333 may include a collection of data, address and control lines. In another example, a main management processing core 354 may generate a transaction on the system bus 320 targeting an address 363 that corresponds to an I/O space register 308 for such purposes as controlling a video effect. The out-of-band decode engine 330 recognizes the address 363 and directs the transaction to an interconnect 333 that is connected to the I/O space register 308.

In another example, the video display interface 310 corresponds to a standalone component that is not part of the BMC 329. In an example, a main management processing core 354 may generate a transaction on the system bus 320 targeting an address 362 that corresponds to a configuration space I/O port of the video display interface 310 for such purposes as initializing or configuring the video display interface 310. The out-of-band decode engine 330 recognizes the address 362 and directs the transaction to an interconnect 333 that is connected to the configuration space I/O port. For this example, interconnect 333 may be a peripheral bus (e.g., an I2C bus, an I3C bus, a SPI bus, an eSPI bus, an SMBus, an Advanced High-performance Bus (AHB), an Advanced extensible Interface (AXI) bus, or other peripheral bus). In another example, a main management processing core 354 may generate a transaction on the system bus 320 targeting an address 363 that corresponds to an I/O space I/O port of the video display interface 310 for such purposes as controlling a video effect. The out-of-band decode engine 330 recognizes the address 363 and directs the transaction to an interconnect 333 that is connected to the I/O space I/O port.

In another example, a main management processing core 354 may generate a transaction on the system bus 320 targeting a frame buffer address 364 associated with the video display interface 310. In an example, a video controller of the video display interface 310 is part of the BMC 329, and a frame buffer associated with the video display interface 310 corresponds to a designated part of the memory 355. The out-of-band decode engine 330 recognizes the frame buffer address 364 and directs the transaction to the designated part of the memory 355. In another example, the video controller is not part of the BMC 329, and the out-of-band decode engine 330 directs the transaction to an interconnect 333 for a memory corresponding to the frame buffer.

As also depicted in FIG. 3, the video display interface 310 is connected to an in-band communication channel 303. For the depicted example implementation, the in-band communication channel 303 includes a PCIe interface 388 of the video display interface 310 and a PCIe link 389 that connects the PCIe interface 388 to a PCIe root complex of the computer platform.

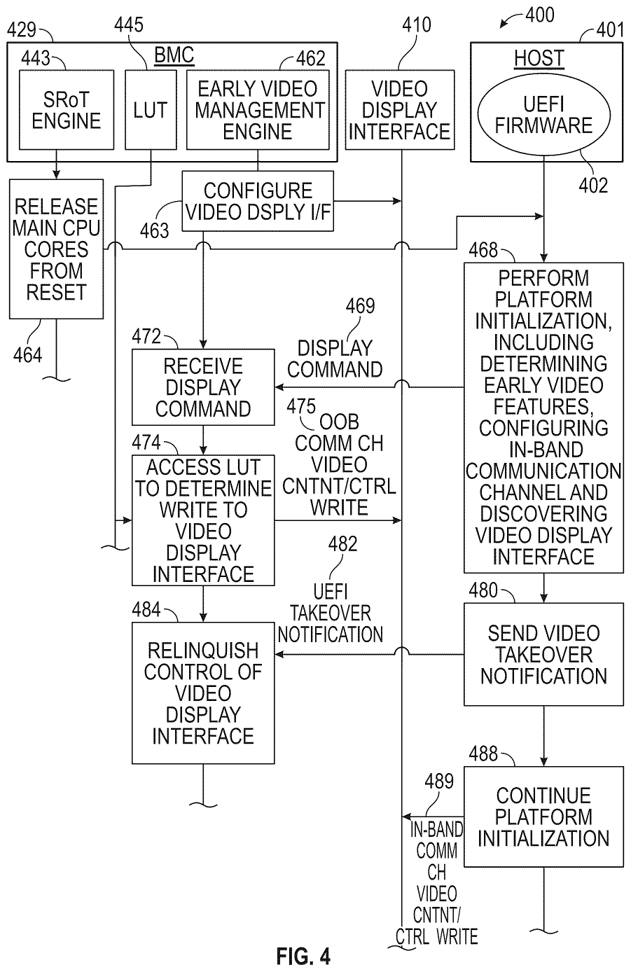

FIG. 4 is a sequence flow diagram 400 illustrating communications of and actions taken by components of an early video solution to generate early video for a computer platform during UEFI firmware execution, in accordance with example implementations. Referring to FIG. 4, the sequence 400 is initiated in response to a host power on request. It is assumed that a video display interface 410 and power consuming components of a host 401 are powered up at the beginning of the sequence. Moreover, it is assumed that a BMC 429 of the computer platform is powered by auxiliary power. Although not depicted in FIG. 4, in accordance with example implementations, an SoC of the computer platform may generate early video during SoC initialization (prior to UEFI firmware execution) by sending display commands to the BMC 429 in a similar manner to what is described below during the UEFI firmware execution.

FIG. 4 depicts the video display interface 410 as being external to the BMC 429. For these implementations, the video display interface 410 may, in an example, be powered by the main power supply of the computer platform. In accordance with further implementations, components (e.g., all components of the video display interface 410 except for a video memory) of the video display interface 410 may be located inside the BMC 429, and in an example, all of the components of the video display interface 410 are powered by auxiliary power.

The video display interface 410 is connected to the host 401 by an in-band communication channel that is subject to complex configuration. As such, without an early video management engine 462 of the BMC 429, video for the computer platform may be unavailable for a substantial duration (seconds, if not minutes) after the host power on request is initiated. For purposes of generating early video, the early video management engine 462 controls the video display interface 410 via an out-of-band communication channel. The BMC 429 manages the host 401. Among its other features, the BMC 429 includes an SRoT engine 443 and a look-up table 445. The BMC 129, the video display interface 110, the early video management engine 162 and the SRoT engine 143 of FIG. 1 are examples of the BMC 429, the video display interface 410, the early video management engine 462 and the SRoT engine 443, respectively.

Responsive to the host power on request, the early video management engine 462, as depicted at 463, configures the video display interface 410 for early video. In accordance with example implementations, the configuration allows the video output of the video display interface 410 be controlled by the early video management engine 462.

In an example, the BMC 429 masks a reset signal to the video display interface 410, which allows the BMC 429 to use the video display interface 410 before the video display interface 410 is otherwise available. Reset logic of the computer platform is configured to assert the reset terminal of the video display interface 410 (to correspondingly hold the video display interface 410 in reset) when the in-band communication channel for the video display interface 410 is in reset. The BMC 429, in accordance with example implementations, has a configuration register that contains a video reset mask bit. The BMC 429 has logic that is constructed to gate the reset signal based on the state of the video reset mask bit. This mechanism allows the BMC 429 to de-assert the reset signal (and therefore, release the video display interface 410 from reset) when the reset signal would have otherwise been asserted by the computer platform. In an example, the early video management engine 462 writes to the configuration register to place the video reset mask bit in a state that masks the reset signal and allows the video display interface 410 to come out of reset and be used by the early video management engine 462. In an example, the video display interface 410 is powered by auxiliary power, and the video reset mask bit allows the BMC 429 to use the video display interface 410 even if the host 401 is powered off. In another example, the video display interface 410 is powered by main power, and the video reset mask bit allows the BMC 429 to use the video display interface 410 independently from the state of the host's power up sequence (i.e., allows the BMC 429 to use the video display interface 410 even though the in-band communication channel is still in reset).

.Also responsive to the host power on request, the BMC 429 performs various checks (e.g., hardware fault checks and firmware integrity checks) before determining to release the main CPU cores of the host 401 from reset. Responsive to successful results for the checks, the SRoT engine 443 releases the main CPU cores from reset, as depicted at 464. The release of the main CPU cores from reset allows a designated boot CPU core to execute the UEFI firmware 402.

As depicted at 468, the UEFI firmware 402 performs UEFI platform initialization, including performing actions related to SEC, PEI and DXE phases. Assuming no fatal errors occur during the boot, the UEFI platform initialization ultimately results in the host's discovery of the video display interface 410. During UEFI platform initialization but before the host 401 discovers the video display interface 410, as also depicted at 468, the UEFI firmware 402 determines video features to be included in the early video. The video features may include messages, progress bars, reporting of error events, displaying UEFI initialization progress, images, logos, a guide for user-selectable boot options, a scrolling effect, a flashing effect, as well as other video features.

FIG. 4 depicts an exemplary communication between the UEFI firmware 402 and the early video management engine 462 for purposes of including a particular video feature in the early video. As depicted at 468, as a result of the UEFI platform initialization and before the host's discovery of the video display interface 410, the UEFI firmware 402 sends a display command 469 to the early video management engine 462. In an example, the UEFI firmware 402 sends the display command 469 to the early video management engine 462 via a UART communication channel between an SoC of the host 401 and the BMC 429.

In an example, the display command 469 is a unit of data that represents a string of characters, and a prefix of the string identifies the string as corresponds to a particular command code, which is represented by the remaining part of the string. In accordance with example implementations, the UEFI firmware 402 matches a particular early video feature with the corresponding command code, and the display command 469 includes data representing the command code.

The early video management engine 462, in accordance with example implementations, receives the display command 469, as depicted at 472. In an example, the reception of the display command 469 corresponds to the early video management engine 462 being alerted to data in the BMC's UART buffer, which represents the display command 469. In an example, the early management engine 462 examines data received in the BMC's UART buffer for purposes of determining whether the data has a certain prefix (e.g., an escape sequence) that identifies the data as representing a display command. If so, the early video management engine 462 extracts the command code from the display command.

For purposes of mapping the command code contained in the display command 469 to a particular early video feature, the early video management engine 462 accesses the look-up table 445, as depicted at 474. The look-up table 270 of FIG. 2 is an example of the look-up table 445. In accordance with further implementations, the early video management engine 462 determines the early video feature corresponding to the command code in another way. In an example, the early video management engine 462 applies a rule to the command code to derive the early video feature. In another example, the command code is self-describing (or “self-contained”) and therefore, directly indicates or represents the corresponding early video feature.

In an example, the look-up table 445 corresponds to a particular firmware volume (e.g., an UEFI volume). In an example, responsive to the BMC 429 powering up, the early video management engine 462 retrieves and stores a copy of the firmware volume in a memory of the BMC 420. The early video management engine 462 uses the look-up table 445 to identify an early video feature to which the associated command code is mapped. The early video management engine 462 then initiates, as depicted at 475, a write to the video display interface 410 to apply the early video feature to the early video. In examples, the write is a write to a display buffer of the video display interface 410 or a write to a control register of the video display interface 410. Moreover, the early video management engine 462 may initiate multiple writes to the video display interface 410 for purposes of including the video content item in the early video. Applying a particular early video feature may also involve the early video management engine 462 reading from the video display interface 410.

The UEFI firmware 402, as part of the platform initialization (block 468), eventually discovers and configures endpoint devices that are connected to in-band communication channels that are subject to complex configurations, such as the in-band communication channel that is connected to the video display interface 410. In an example, the in-band communication channel connected to the video display interface 410 is a PCIe link. The UEFI firmware 402 performs extensive and complex operations to configure the in-band communication channel. After the in-band communication channel is configured, the UEFI firmware 402 performs PCIe enumeration, which results in the discovery of the video display interface 410 by the UEFI firmware 402. At this point, the UEFI firmware 402 allocates system resources and configures the video display interface 410 based on the allocation. The UEFI firmware 402 may thereafter access the video display interface 410 for purposes of producing video content.

The UEFI firmware 402, as depicted at 480, sends a video takeover notification 482 to the early video management engine 462 to inform the engine 462 that the host 401 is taking over control of the video display interface 410. Responsive to receiving the video takeover notification 482, the early video management engine 462 relinquishes controlling the video display interface 410, as depicted at 484.

In an example, for purposes of sending the video takeover notification, the UEFI firmware 402 sends, to the early video management engine 462 and via a UART communication channel, a display command containing a command code that is uniquely associated with a video takeover notification. In another example, the UEFI firmware 402 notifies the early video management engine 462 as to the video takeover by sending, to the engine 462 and via a UART communication channel, data representing a string of characters and having a non-command prefix that is uniquely associated with a video takeover notification.

In an example, the UEFI firmware 402 waits for an acknowledgment from the early video management engine 462 for the video takeover notification before the UEFI firmware 402 takes over control of the video display interface 410, and the UEFI firmware 402 may send one or multiple additional video takeover notifications (assuming no acknowledgements) before taking over control of the video display interface 410. In an example, the early video management engine 462 sends a confirmation to the UEFI firmware 402 via the out-of-band channel. In another example, the early video management engine 462 neither acknowledges the video takeover notification nor is expected by the UEFI firmware 402 to do so, and the host 401 takes over control of the video display interface 410 after sending the video takeover notification.

In an example, as part of relinquishing control of the video interface controller, the early video management engine 462 configures the video display interface 410 to no longer be controlled by the engine 462. In another example, the early video management engine 462 does not perform any further writes to the video display interface 410 after receiving a takeover notification, and as such, relinquishing control of the video display interface 410 does not involve any further action by the early video management engine 462.

Access synchronization to the video display interface 410 (a shared resource) may occur in any of a number of different ways, including the sending of a video takeover notification, as described in connection with FIG. 4. In another example, the UEFI firmware 402 does not send a takeover notification or otherwise notify the early video management engine 462 about the takeover of the video display interface 410. Instead, the UEFI firmware 402 configures the video display interface 410 so that registers of the video display interface 410 are “read only” to the BMC 429, thereby preventing the early video management engine 462 from thereafter controlling the video display interface 410.

After taking over responsibility for the video, the UEFI firmware 402 may then, as depicted at 488, continue to perform platform initialization operations. As a result of these platform initialization operations, the UEFI firmware 402 may identify or determine early video features of the later video. FIG. 4 depicts the UEFI firmware 402, in connection with performing the platform initialization operations of block 488, initiating a write 489 to the video display interface 410 to include a particular video content item in the video. In an example, the write 489 is a write to a display buffer of the video display interface 410 or a write to a control register of the video display interface 410. Moreover, the UEFI firmware 402 may initiate multiple writes to the video display interface 410 for purposes of including the video content item in the video.

In the context that is used herein, a BMC is a specialized service processor that monitors the physical state of a server or other hardware using sensors and communicates with a management system through a management network. The BMC may also communicate with applications executing at the operating system level through an input/output controller (IOCTL) interface driver, a representational state transfer (REST) application program interface (API), or some other system software proxy that facilitates communication between the BMC and applications. The BMC may have hardware level access to hardware devices that are located in a server chassis including system memory. The BMC may be able to directly modify the hardware devices. The BMC may operate independently of the operating system of the system in which the BMC is disposed. A BMC may be located on the motherboard or main circuit board of the server or other device to be monitored.

The fact that a BMC is mounted on a motherboard of the managed server/hardware or otherwise connected or attached to the managed server/hardware does not prevent the BMC from being considered “separate” from the server/hardware. As used herein, BMC has management capabilities for sub-systems of a computing device, and is separate from a processing resource that executes an operating system of a computing device. The BMC is separate from a processor, such as a central processing unit, which executes a high-level operating system or hypervisor on a system.

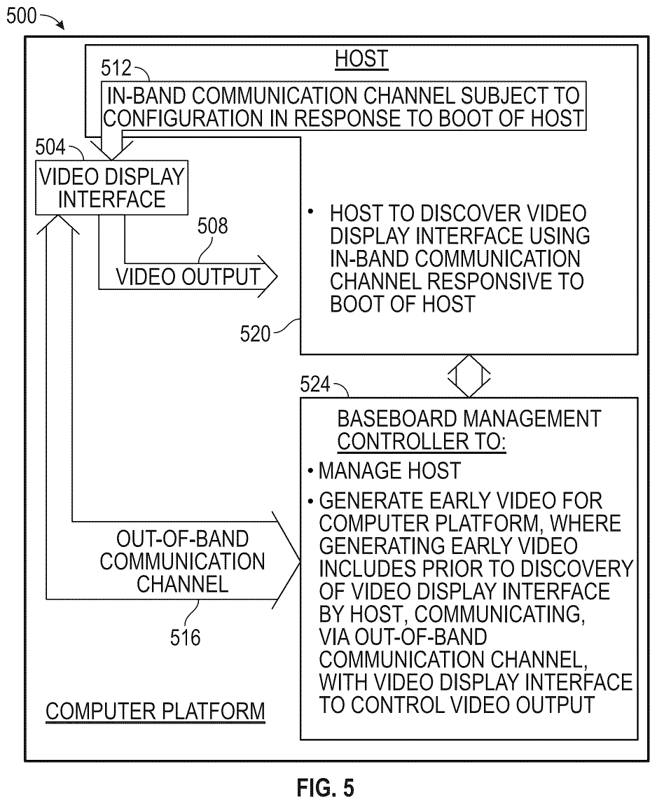

Referring to FIG. 5, in accordance with example implementations, a computer platform 500 includes an out-of-band communication channel 516; a video display interface 504; a host 520; and a BMC 524. In an example, the computer platform 500 is a server, such as a blade server, a rack server or a tower server. In other examples, the computer platform 500 is a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device. In an example, the computer platform 500 includes an SoC. In an example, the host 520 corresponds to an HPM, and the BMC 524 corresponds to a DC-SCM. In an example, components (e.g., video controller and PCIe interface) of the video display interface 504 is part of the BMC 524.

The video display interface 504 provides a video output 508. In an example, the video output 508 is collection of analog video output signals. In an example, the video output is VGA-compliant. In another example, the video output 508 is a collection of digital video output signals. In another example, the video output 508 is a collection of analog and digital video output signals.

The host 520 includes an in-band communication channel 512. In an example, the host 520 includes one or multiple processing cores (e.g., CPU cores), including a processing core that executes system firmware. In an example, the host 520 includes an SoC having a service processing core. In an example, the in-band communication channel 512 is a PCIe link.

In an example, the out-of-band communication channel 516 includes a system bus of the BMC 524. In an example, the out-of-band communication channel includes 516 includes a decode engine of the BMC 524, which recognizes system bus transactions targeting addresses within the BMC's memory address space and which correspond to resources (e.g., registers, I/O ports and video memory) of the video display interface 504.

The in-band communication channel 512 is configured in response to a boot of the host. In an example, the configuration corresponds to extensive and complex initialization and configuration operations that are performed by system firmware (e.g., UEFI firmware) on each host boot for purposes of preparing the in-band communication channel 512 for its use. In an example, the in-band communication channel 512 is a PCIe link, which means that the in-band communication channel 512 is not available until the associated PCIe root complex is initialized and configured. In examples, the initialization and configuration of the PCIe root complex may involve, among other operations, PCIe link training; selecting whether PCIe lanes use PCIe or CXL protocols; selecting lane widths; selecting lane groupings; selecting PCIe power supply levels; and negotiating and establishing PCIe link parameters (e.g., data rates and equalization parameters).

The host 520, responsive to the boot, discovers the video display interface 504 using the in-band communication channel responsive to a boot of the host 520. In an example, the host 520 discovers the video display interface 504 by executing system firmware instructions. In an example, the host 520 performs PCIe enumeration and discovers the video display interface 504 in the PCIe enumeration. In an example, the host 520 performs platform initialization during the boot, and the PCIe enumeration occurs during the platform initialization. In an example, a hardware processor of the host 520 executes UEFI firmware instructions to perform a DXE platform initialization phase during the boot, and the PCIe enumeration occurs during the DXE platform initialization phase.

Responsive to the discovery of the video display interface 504, the host 520 communicates with the video display interface 504 via the in-band communication channel 512 to control the video output 508. In an example, controlling the video output 508 includes a hardware processor of the host 520 writing, via the in-band communication channel 512, data to a display memory of the video display interface 504. In an example, controlling the video output 508 includes a hardware processor of the host 520 writing, via the in-band communication channel 512, data to a register of the video display interface 504.

The BMC 524 manages the host 520. In an example, the BMC 524 managing the host 520 includes the BMC 524 providing one or multiple management services for the host 520 in association with the BMC's management plane. In examples, the BMC 524 provides such management services as operating system runtime services; resource detection and initialization; and pre-operating system services. Some management services may be remotely-managed. As examples, remotely-managed management services include KVM services; virtual power services; and virtual media management services.

In an example, the BMC 524 managing the host 520 includes the BMC 524 providing one or multiple security services for the host 520 in connection with the BMC's security plane. In examples, the security services may include firmware validation; managing the storage of cryptographic artifacts (e.g., certificates, seeds, cryptographic keys; measurements; and passwords) for the host 520; encryption; decryption; tamper detection; random number generation; pseudorandom number generation; hash generation, measurement signing; among other security-related operations.

The BMC 524 generates an early video for the computer platform 500. Generating the early video includes, responsive to the boot of the host 520 and prior to discovery of the video display interface 504 by the host 520, communicating, via the out-of-band communication channel 516, with the video display interface 504 to control the video output 508. In an example, a hardware processor of the host 520 sends, to the BMC 524, display codes representing video content items for the early video. In an example, the hardware processor sends the display codes to the BMC 524 using a UART-based communication channel.

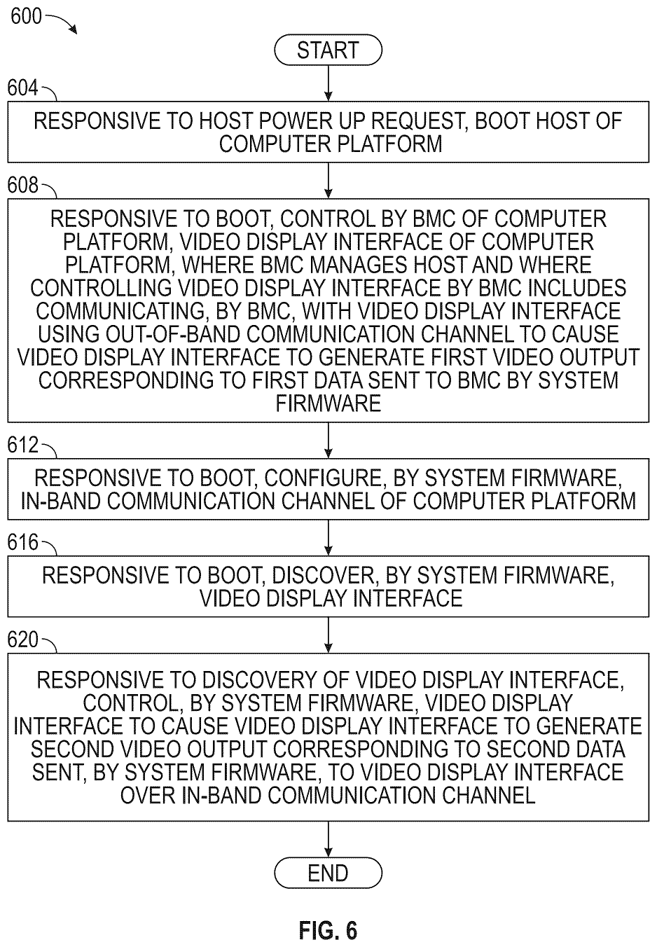

Referring to FIG. 6, in accordance with example implementations, a technique 600 includes, responsive to a host power up request, booting (block 604) a host of a computer platform. In an example, the host power up request corresponds to a power button of the computer platform being depressed. In another example, a host power on request is initiated by a BMC of the computer platform instead of the host power on request being initiated by a power button being depressed. In an example, a root-of-trust engine of the computer platform controls whether the boot is allowed based on checks performed by the engine. In an example, a root-of-trust engine of the computer platform controls whether the boot is allowed based on a firmware validity check.

In an example, the computer platform is a server, such as a blade server, a rack server or a tower server. In other examples, the computer platform is a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device. In an example, the computer platform includes an SoC.

Pursuant to block 608, the technique 600 includes, responsive to the booting, controlling, by a BMC of the computer platform, a video display interface of the computer platform. In an example, the video display interface provides a collection of VGA-compliant analog video output signals. In another example, the video display interface provides a collection of digital video output signals. In another example, the video display interface provides a collection of analog and digital video output signals.

The BMC manages the host. In an example, the BMC managing the host includes the BMC providing one or multiple management services for the host in association with the BMC's management plane. In examples, the BMC provides such management services as operating system runtime services; resource detection and initialization; and pre-operating system services.

Some management services may be remotely-managed. As examples, remotely-managed management services include KVM services; virtual power services; and virtual media management services. In an example, the BMC managing the host includes the BMC providing one or multiple security services for the host in connection with the BMC's security plane. In examples, the security services may include firmware validation; managing the storage of cryptographic artifacts (e.g., certificates, seeds, cryptographic keys; measurements; and passwords) for the host 100; encryption; decryption; tamper detection; random number generation; pseudorandom number generation; hash generation, measurement signing; among other security-related operations.

The BMC controlling the video display interface includes communicating, by the BMC, with the video display interface using an out-of-band communication channel to cause the video display interface to generate a first video output corresponding to first data sent to the baseboard management controller by system firmware. In an example, the out-of-band communication channel includes an internal bus of the BMC. In an example, the out-of-band communication channel includes a system bus of the BMC. In an example, the out-of-band communication channel is associated with a mapping of a video display memory of the video display interface to a memory address space of the BMC. In an example, the out-of-band communication channel is associated with a mapping of a register of the video display interface to an I/O address space of the BMC.

In an example, the out-of-band communication channel is associated with a mapping of a register of the video display interface to an MMIO address space of the BMC. In an example, the out-of-band communication channel includes a peripheral bus, such as an I2C bus, an I3C bus, a SPI bus, an eSPI bus, SMBus, AXI bus or AHB.

The technique 600 includes, pursuant to block 612, responsive to the booting, configuring, by the system firmware, an in-band communication channel of the computer platform. In an example, the in-band communication channel is a PCIe link. In an example, the system firmware is UEFI firmware. In another example, the system firmware is BIOS firmware. In another example, the system firmware is Coreboot firmware. In an example, the host 520 sends, to the BMC 524, video display commands representing early video. In an example, the host 520 sends the video display commands to the BMC 524 using a UART-based communication channel.

The technique 600 includes, pursuant to block 616, responsive to the booting, discovering, by the system firmware, the video display interface. In an example, discovering the video display interface includes performing PCIe enumeration. In an example, discovering the video display interface occurs as part of platform initialization by the system firmware during the boot. The technique 600 further includes, pursuant to block 620, responsive to discovering the video display interface, controlling, by the system firmware, the video display interface to cause the video display interface to generate a second video output corresponding to second data sent, by the firmware agent, to the video display interface over the in-band communication channel.

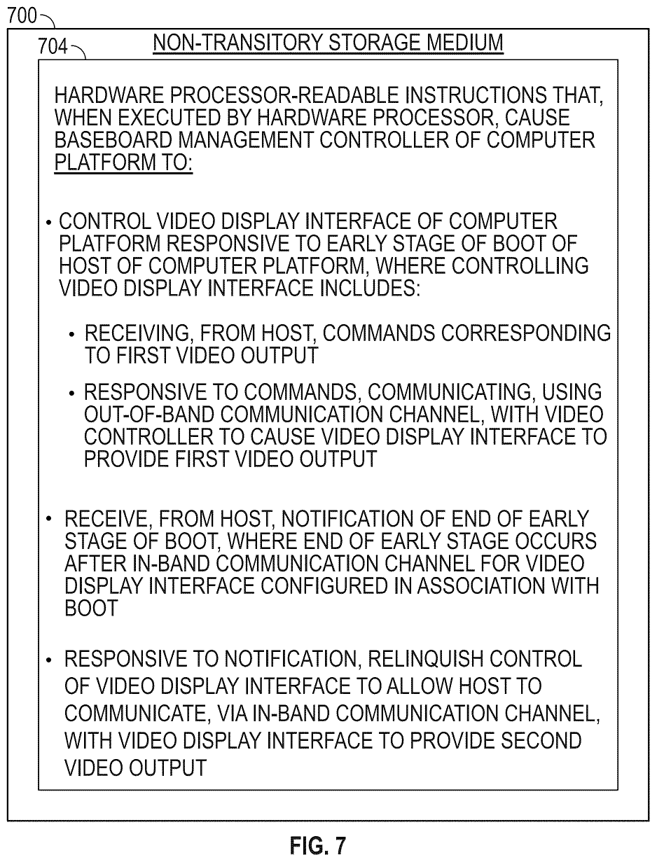

Referring to FIG. 7, in accordance with example implementations, a non-transitory storage medium 700 stores hardware processor-readable instructions 704 that, when executed by a hardware processor, cause a BMC of a computer platform to control a video display interface of the computer platform responsive to an early stage of a boot of a host of the computer platform. In an example, the storage medium 700 includes a collection of non-transitory memory devices, such as semiconductor storage devices, flash memory devices, memristors, phase change memory devices, a combination of one or more of the foregoing storage technologies, and so forth. In examples, the memory devices may be volatile memory devices (e.g., DRAM devices, SRAM) devices, and so forth) or non-volatile memory devices (e.g., flash memory devices, ROM devices and so forth). In an example, the hardware processor includes a collection of one or multiple processing cores. In an example, the hardware processor includes a collection of one or multiple CPU cores.

In an example, the BMC includes a semiconductor package that is mounted to a motherboard of the computer platform. In an example, the semiconductor package contains one or multiple dies (corresponding to respective integrated circuits) that are mounted on a PCB substrate that interconnects the dies. In another example, the semiconductor package contains multiple dies that are interconnected by bonding wires. In an example, the semiconductor package is encapsulated. In another example, the semiconductor package is not encapsulated. In other examples, the semiconductor package may correspond to any of a number of different containers, such as a surface mount package, a through-hole package, a ball-grid array package, a small outline package or a chip-scale package. In an example, the semiconductor package is mounted to a PCBA that corresponds to a DC-SCM. In another example, the semiconductor package is mounted to a motherboard of the computer platform.

In an example, the computer platform is a server, such as a blade server, a rack server or a tower server. In other examples, the computer platform is a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device. In an example, the computer platform includes an SoC.

In an example, the video display interface provides a collection of VGA-compliant analog video output signals. In another example, the video display interface provides a collection of digital video output signals. In another example, the video display interface provides a collection of analog and digital video output signals. In an example, the video display interface is contained in a package (e.g., a semiconductor package) that is external from the BMC. In another example, the video display interface has components that are associated with the BMC. In an example, a video controller of the video display interface is contained in the BMC's semiconductor package. In an example, a video controller of the video display interface is fabricated in a die in which other components of the BMC are fabricated. In an example, a PCIe endpoint interface of the video display interface is fabricated in a die contained in the BMC's semiconductor package. In an example, the BMC and the video display interface share a volatile memory.

In an example, the early stage of the boot corresponds to a time period beginning when the boot begins and ending when the host discovers the video display interface. In an example, an in-band communication channel connected to the video display interface is configured during the time period. In an example, the host communicates with the video display interface using the in-band communication channel. In an example, the in-band communication channel is a PCIe link, which means that the in-band communication channel is not available until the associated PCIe root complex is initialized and configured. In examples, the initialization and configuration of the PCIe root complex may involve, among other operations, PCIe link training; selecting whether PCIe lanes use PCIe or CXL protocols; selecting lane groupings; selecting bus supply voltages; selecting lane widths; and negotiating and establishing PCIe link parameters (e.g., data rates and equalization parameters).

Controlling the video display interface includes receiving, from the host, commands corresponding to a first video output; and responsive to the commands, communicating, using an out-of-band communication channel, with the video display interface to cause the video display interface to provide the first video output. In an example, a command corresponds to data that represents a string of characters, and a prefix of the string represents an escape sequence. In an example, receiving the commands includes the BMC receiving the commands via a UART communication channel. In an example, using the out-of-band communication channel includes the BMC writing to an address space region, which is mapped to an address of the video display interface.

In an example, the BMC accesses a look-up table to convert the commands into early video features that are mapped to codes contained in the commands. In another example, the commands are self-describing and therefore directly indicate or represent corresponding early video features. In another example, the BMC applies rules (e.g., if-then rules) to the commands to derive early video features. In an example, an early video feature may be a video content item, such as a progress bar, a progress bar update percentage, a message, an icon, an image, a logo, a single character or multiple characters. In another example, an early video feature may be an effect to apply to the early video.

The instructions 704, when executed by the hardware processor, further cause the BMC to receive, from the host, a notification of an end of the early stage of the boot. The end of the early stage occurs after an in-band communication channel for the video display interface is configured in association with the boot. In an example, the in-band communication channel includes a PCIe link, which connects the video display interface to a PCIe root complex of the computer platform. In an example, the notification is a video takeover notification indicating that the host is taking over control of the video display interface from the BMC. In an example, the BMC acknowledges the video takeover notification. In another example, the BMC, responsive to receiving the video takeover notification, no longer issues out-of-band accesses to the video display interface. The instructions 704, when executed by the hardware processor, further cause the BMC to, responsive to the notification, relinquish control of the video display interface to allow the host to communicate, via the in-band communication channel, with the video display interface to provide a second video output.

In accordance with example implementations, the host further includes a hardware processor. The hardware processor, responsive to the boot, executes firmware instructions to discover the video display interface using the in-band communication channel. The hardware processor, responsive to the discovery of the video display interface, executes firmware instructions to communicate with the video display interface via the in-band communication channel to control the video output. Among the potential benefits, early video may reveal a boot-related issue that causes a boot to fail before the host discovers the video display interface.

In accordance with example implementations, a region of a memory address space of the baseboard management controller is mapped to a memory address space of the video display interface. Communication, by the baseboard management controller via the out-of-band communication channel, includes the baseboard management controller generating a transaction having an address within the region. Among the potential benefits, early video may reveal a boot-related issue that causes a boot to fail before the host discovers the video display interface.

In accordance with example implementations, a region of a memory address space of the baseboard management controller is mapped to an I/O address space of the video display interface. Communication, by the baseboard management controller via the out-of-band communication channel, includes the baseboard management controller generating a transaction having an address within the region. Among the potential benefits, early video may reveal a boot-related issue that causes a boot to fail before the host discovers the video display interface.

In accordance with example implementations, the baseboard management controller has a memory address space having a subregion corresponding to configuration address space, input/output (I/O) address space and memory address space regions of the video display interface. The communication, by the baseboard management controller, via the out-of-band communication channel includes a processing core of the baseboard management controller generating transactions having addresses within the subregion. Among the potential benefits, early video may reveal a boot-related issue that causes a boot to fail before the host discovers the video display interface.

In accordance with example implementations, the in-band communication channel is held in reset prior to the in-band communication channel being trained, and the video display interface is configured to be in reset responsive to the in-band communication channel being held in reset. The baseboard management controller to further, responsive to initiation of the boot of the host, write to a configuration register to release the video display interface from reset to allow the video display interface to provide the video output while the in-band communication channel is held in reset. Among the potential benefits, early video may reveal a boot-related issue that causes a boot to fail before the host discovers the video display interface.

In accordance with example implementations, the early video feature corresponds to a video content item that includes a message representing a status of a task associated with the host, an indication of a progress of the task, an image, or an error message. Among the potential benefits, early video may reveal a boot-related issue that causes a boot to fail before the host discovers the video display interface.

In accordance with example implementations, the baseboard management controller to further receive a command sent by the hardware processor and corresponding to an early video feature. The baseboard management controller to further, responsive to receiving the command, communicate, via the out-of-band communication channel, with the video display interface to apply the early video feature to the video output. Among the potential benefits, early video may reveal a boot-related issue that causes a boot to fail before the host discovers the video display interface.

In accordance with example implementations, the command includes a string that includes a prefix and a code. The baseboard management controller to further recognize the string prefix and identify the code in response to recognition of the prefix; and look up the early video feature based on the code. Among the potential benefits, early video may reveal a boot-related issue that causes a boot to fail before the host discovers the video display interface.

In accordance with example implementations, the baseboard management controller to further receive, from the host processor, a notification of the host taking over control of the video display interface; and responsive to the notification, cease communicating with the video display interface over the out-of-band communication channel. Among the potential benefits, early video may reveal a boot-related issue that causes a boot to fail before the host discovers the video display interface.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

1. A computer platform comprising:
an out-of-band communication channel;
a video display interface coupled to the out-of-band communication channel, wherein the video display interface to provide a video output;
a host comprising an in-band communication channel coupled to the video display interface, wherein the in-band communication channel to be configured in response to a boot of the host, and wherein the host comprises a host processor to:
execute firmware instructions to discover the video display interface via the in-band communication channel responsive to a boot of the host;
responsive to the discovery of the video display interface via the in-band communication channel, execute firmware instructions to end an early video for the computer platform; and
responsive to the discovery of the video display interface via the in-band communication channel, execute firmware instructions to communicate with the video display interface via the in-band communication channel to control the video output; and
a baseboard management controller to:
manage the host; and
generate the early video, wherein generating the early video comprises responsive to a boot and prior to the discovery of the video display interface by the host, communicating, via the out-of-band communication channel, with the video display interface to control the video output.

2. The computer platform of claim 1, wherein the hardware processor to responsive to the discovery of the video display interface via the in-band communication channel, configure the video display interface to prevent the baseboard management controller from controlling the video display interface.

3. The computer platform of claim 1, wherein:
a region of a memory address space of the baseboard management controller is mapped to a memory address space of the video display interface; and
communication, by the baseboard management controller via the out-of-band communication channel, comprises the baseboard management controller generating a transaction having an address within the region.

4. The computer platform of claim 1, wherein:
a region of a memory address space of the baseboard management controller is mapped to an input/output (I/O) address space of the video display interface; and
communication, by the baseboard management controller via the out-of-band communication channel, comprises the baseboard management controller generating a transaction having an address within the region.

5. The computer platform of claim 1, wherein:
the baseboard management controller has a memory address space having a subregion corresponding to configuration address space, input/output (I/O) address space and memory address space regions of the video display interface; and
communication, by the baseboard management controller, via the out-of-band communication channel comprises a processing core of the baseboard management controller generating transactions having addresses within the subregion.

6. The computer platform of claim 1, wherein:
the in-band communication channel is held in reset prior to the in-band communication channel being trained;
the video display interface is configured to be in reset responsive to the in-band communication channel being held in reset; and
the baseboard management controller to further:
responsive to initiation of the boot of the host, write to a configuration register to release the video display interface from reset to allow the video display interface to provide the video output while the in-band communication channel is held in reset.

7. The computer platform of claim 1, wherein the baseboard management controller to further:
receive a command sent by the hardware processor and corresponding to an early video feature; and
responsive to receiving the command, communicate, via the out-of-band communication channel, with the video display interface to apply the early video feature to the video output.

8. The computer platform of claim 7, wherein the early video feature corresponds to a video content item comprising a message representing a status of a task associated with the host, an indication of a progress of the task, an image, or an error message.

9. The computer platform of claim 7, wherein:
the command comprises a string comprising a prefix and a code; and
the baseboard management controller to further:
recognize the string prefix and identify the code in response to recognition of the prefix; and
look up the early video feature based on the code.

10. The computer platform of claim 1, wherein:
the hardware processor to further, responsive to the discovery of the video display interface via the in-band communication channel, send, to the baseboard management controller, a notification of the host taking control of the video display interface; and
the baseboard management controller to further:
receive, from the hardware host processor, the notification; and
responsive to the notification, cease communicating with the video display interface over the out-of-band communication channel.

11. A method comprising:
responsive to a host power up request, booting a host of a computer platform;
responsive to the booting, controlling, by a baseboard management controller of the computer platform, a video display interface of the computer platform, wherein the baseboard management controller manages the host, and wherein controlling, by the baseboard management, the video display interface comprises communicating, by the baseboard management controller, with the video display interface using an out-of-band communication channel to cause the video display interface to generate a first video output corresponding to first data sent to the baseboard management controller by system firmware;
responsive to the booting, configuring, by the system firmware, an in-band communication channel of the computer platform, wherein the controlling, by the baseboard management controller, of the video display interface occurs during the configuring, by the system firmware, of the in-band communication channel;
responsive to the booting, discovering, by the system firmware, the video display interface; and
responsive to discovering the video display interface, controlling, by the system firmware, the video display interface to generate a second video output corresponding to second data sent, by the system firmware, to the video display interface over the in-band communication channel.

12. The method of claim 11, wherein controlling the video display interface comprises writing, by the baseboard management controller, content to a video display memory associated with the video display interface.

13. The method of claim 11, wherein controlling the video display interface comprises writing, by the baseboard management controller, to a register of the video display interface.

14. The method of claim 11, further comprising:
receiving, by the baseboard management controller and from the system firmware agent, a display command representing a code; and
determining, by the baseboard management controller, a feature of the first video output based on the code.

15. The method of claim 11, wherein:
training the in-band communication channel comprises training a Peripheral Component Interconnect express (PCIe) link; and
discovering the video display interface comprises performing PCIe enumeration.

16. A non-transitory storage medium that stores hardware processor-readable instructions that, when executed by a hardware processor, cause a baseboard management controller of a computer platform to:
control a video display interface of the computer platform responsive to an early stage of a boot of a host of the computer platform, wherein controlling the video display interface comprises:
receiving, from the host, commands corresponding to a first video output; and
responsive to the commands, communicating, using an out-of-band communication channel, with the video display interface to cause the video display interface to provide the first video output;
receive, from the host and after configuration, by the host, of an in-band communication channel for the video display interface, a notification of a takeover of control of the video display interface by the host; and
responsive to the notification, relinquish control of the video display interface to allow the host to communicate, via the in-band communication channel, with the video display interface to provide a second video output.

17. The storage medium of claim 16, wherein the instructions, when executed by the hardware processor, further cause the baseboard management controller to configure the video display interface to allow the baseboard management to control the first video output using the out-of-band communication channel.

18. The storage medium of claim 16, wherein:
the out-of-band communication channel corresponds to a region of a memory address space of the baseboard management controller being mapped to a memory address space of the video display interface; and
the instructions, when executed by the hardware processor, further cause the baseboard management controller to write to the region to communicate, using the out-of-band communication channel, with the video display interface to cause the video display interface to provide the first video output.

19. The storage medium of claim 16, wherein:
a given command of the commands indicates a code; and
the instructions, when executed by the hardware processor, further cause the baseboard management controller to, responsive to the given command, access a look-up table to identify a feature of the first video.

20. The storage medium of claim 19, wherein the feature comprises a video content item to be included in the first video.

21. The method of claim 11, further comprising:
responsive to discovering, by the system firmware, the video display interface, terminating, by the system firmware interface, the controlling of the video display interface by the baseboard management controller.

22. The method of claim 21, wherein the terminating comprises at least one of:
sending, by the system firmware and to the baseboard management controller, a takeover notification to indicate that the system firmware is taking control of the video display interface; or
configuring, by the system firmware, the video display interface, to disable the controlling of the video display interface by the baseboard management controller.
